(19) United States
(12) Patent Application Publication
(10) Pub. No.: US 2024/0312324 A1
(43) Pub. Date: Sep. 19, 2024

(54) PRODUCT DISTRIBUTION

(71) Applicant: South Pacific Laundry (Melbourne) Pty Ltd, Broadmeadows (AU)

(72) Inventors: Isaac HAYES, Victoria (AU); Ray HAYES, Victoria (AU); Ian KRIGSMAN, Victoria (AU)

(21) Appl. No.: 18/546,760

(22) PCT Filed: Feb. 17, 2022
(86) PCT No.: PCT/AU2022/050109

§ 371 Date: Aug. 16, 2023

(30) Foreign Application Priority Data
Feb. 17, 2021 (AU) 2021900393
Aug. 25, 2021 (AU) 2021221685

(51) Int. Cl. G08B 13/24; G06Q 10/087; G07C 9/28

(52) U.S. Cl. CPC G08B 13/2417; G06Q 10/087; G07C 9/28

(57) ABSTRACT

A product distribution system comprising a product storage area, an RFID portal (to identify product taken from the product storage area) and a shield to shield the RFID portal from the product storage area.

### FIELD OF THE INVENTION

The invention relates to product distribution.

The technology disclosed herein will be described with reference to the distribution of laundered products by way of example only. Other variants of the technology disclosed herein may be applicable in other contexts.

### BACKGROUND TO THE INVENTION

Many commercial laundries service a wide range of users such as hoteliers and hospitals. Frequently the cost of collecting the items in need of laundering and then distributing the laundered items is significant and indeed can outweigh the costs of laundering per se.

The present invention aims to provide improvements in and for product distribution and methods entailing product distribution, or at least to provide a useful alternative for those concerned with such things.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

### SUMMARY

In a first aspect, the present disclosure provides a product distribution system comprising:
a product storage area;
an RFID portal to identify product taken from the product storage area,
a product return area separate from the product storage area, and
an RFID reader to identify product in the product return area, the RFID reader being separate from the RFID portal.

In a second aspect, the present disclosure provides a product distribution system comprising:
a product storage area;
an RFID portal to identify product taken from the product storage area, and
a shield to shield the RFID portal from the product storage area.

In one embodiment, the shield comprises a metallic wall.

In one embodiment, the product distribution system comprises a transportable unit.

In one embodiment, the product distribution system comprises mounting points by which the transportable unit is mountable in place of a shipping container.

In one embodiment, the transportable unit may comprise the product storage area and a reader of the RFID portal.

In one embodiment, the product distribution system comprises a product return area separate from the product storage area.

In one embodiment, a wall separates the product return area from the product storage area.

In one embodiment, the product distribution system comprises an RFID reader to identify product in the product return area.

In one embodiment, RF-identifiable used-and-laundered product may be stacked, or hung, in the product storage area.

In one embodiment, the RFID portal comprises an exit area and a door from the product storage area to the exit area.

In one embodiment, the RFID portal is a UHF RFID portal.

In one embodiment, the product distribution system comprises a user identification system.

In one embodiment, the product distribution system comprises a database configured to log product taken from the product storage area by each user.

In one embodiment, the product distribution system comprises a locking system configured to grant access to the product distribution system based on user identity.

In one embodiment, the product distribution system comprises a source of electricity to operate without the need for mains-supply electricity.

In one embodiment, the product distribution system comprises one or more electricity-producing solar devices.

In a third aspect, the present disclosure provides a product distribution system comprising a transportable unit, wherein the transportable unit comprises: a product storage area; and a reader of an RFID portal to identify product taken from the product storage area.

In one embodiment, the product distribution system comprises mounting points by which the transportable unit is mountable in place of a shipping container.

In one embodiment, the product distribution system comprises a product return area separate from the product storage area.

In one embodiment, a wall separates the product return area from the product storage area.

In one embodiment, RF-identifiable used-and-laundered product may be stacked, or hung, in the product storage area.

In one embodiment, the RFID portal comprises an exit area and a door from the product storage area to the exit area.

In one embodiment, the product distribution system includes a shield to shield the product storage area from the exit area.

In one embodiment, the shield comprises a metallic wall.

In one embodiment, the RFID portal is a UHF RFID portal.

In one embodiment, the product distribution system comprises a user identification system.

In one embodiment, the product distribution system comprises a database configured to log product taken from the product storage area by each user.

In one embodiment, the product distribution system comprises a locking system configured to grant access to the product distribution system based on user identity.

In one embodiment, the product distribution system comprises a source of electricity to operate without the need for mains-supply electricity.

In one embodiment, the product distribution system comprises one or more electricity-producing solar devices.

In a fourth aspect, the present disclosure provides a product distribution system comprising:
a product storage area;
an RFID portal to identify product taken from the product storage area, and
a product return area separate from the product storage area.

In one embodiment, a wall separates the product return area from the product storage area.

In one embodiment, the product distribution system comprises an RFID reader to identify product in the product return area.

In one embodiment, RF-identifiable used-and-laundered product may be stacked, or hung, in the product storage area.

In one embodiment, the RFID portal comprises an exit area and a door from the product storage area to the exit area.

In one embodiment, the product distribution system comprises a shield to shield the RFID portal from the product storage area.

In one embodiment, the shield is a metallic wall.

In one embodiment, the product distribution system comprises a user identification system.

In one embodiment, the product distribution system comprises a database configured to log product taken from the product storage area by each user.

In one embodiment, the product distribution system comprises a locking system configured to grant access to the product distribution system based on user identity.

In one embodiment, the product distribution system comprises a source of electricity to operate without the need for mains-supply electricity.

In one embodiment, the product distribution system comprises one or more electricity-producing solar devices.

In a fifth aspect, the present disclosure provides a product distribution system comprising:
a product storage area;
an RFID portal to identify product taken from the product storage area, and
RF-identifiable used-and-laundered product being stacked, or hung, in the product storage area.

In one embodiment, the RFID portal comprises an exit area and a door from the product storage area to the exit area.

In one embodiment, the product distribution system comprises a shield to shield the RFID portal from the product storage area.

In one embodiment, the shield is a metallic wall.

In one embodiment, the product distribution system comprises a transportable unit.

In one embodiment, the product distribution system comprises mounting points by which the transportable unit is mountable in place of a shipping container.

In one embodiment, the transportable unit may comprise the product storage area and a reader of the RFID portal.

In one embodiment, the product distribution system comprises a product return area separate from the product storage area.

In one embodiment, a wall separates the product return area from the product storage area.

In one embodiment, the product distribution system comprises an RFID reader to identify product in the product storage area.

In one embodiment, the RFID portal is a UHF RFID portal.

In one embodiment, the product distribution system comprises a locking system configured to grant access to the product distribution system based on user identity.

In one embodiment, the product distribution system comprises a user identification system.

In one embodiment, the product distribution system comprises a database configured to log product taken from the product storage area by each user.

In one embodiment, the product distribution system comprises a locking system configured to grant access to the product distribution system based on user identity.

In one embodiment, the product distribution system comprises a source of electricity to operate without the need for mains-supply electricity.

In one embodiment, the product distribution system comprises one or more electricity-producing solar devices.

In one embodiment, the RFID portal is a UHF RFID portal.

In one embodiment, the product storage area is adapted to store RF-identifiable laundered product including linens and/or clothing.

In one embodiment, the product return area is adapted to receive linen and/or clothing items in need of laundering.

In a sixth aspect, the present disclosure provides a method comprising:
collecting used product to form collected product;
servicing the collected product to form serviced product;
transporting the serviced product to a product distribution system, and
allowing users to take the serviced product from the product distribution system;
   wherein the product distribution system comprises:
a product storage area;
an RFID portal to identify product taken from the product storage area.

In one embodiment, the step of transporting comprises road transporting.

In one embodiment, the step of servicing comprises laundering.

In one embodiment, the product distribution system is in accordance with any one of the first, second, third, fourth, and fifth aspect of the present disclosure.

### BRIEF DESCRIPTION OF DRAWINGS

Various preferred embodiments of the present disclosure will now be described, by way of examples only, with reference to the accompanying figures, in which:

FIG. 1 is a perspective view of a first embodiment of a product distribution system, and

FIG. 2 is a perspective cutaway view of the product distribution system of FIG. 1, and

FIG. 3 is a perspective cutaway view of another embodiment of a product distribution system.

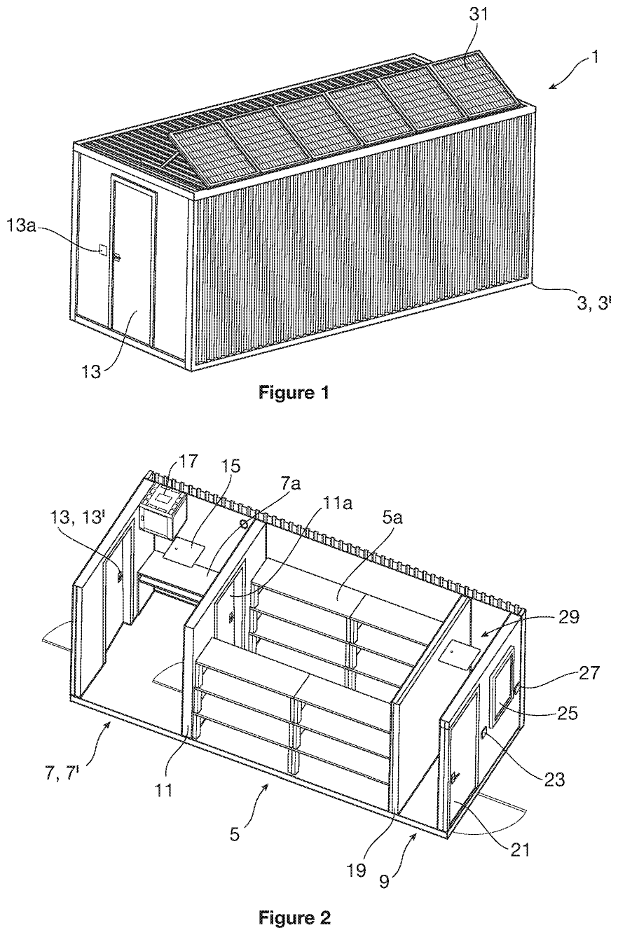

### DETAILED DESCRIPTION

The product distribution system (PDS) 1 is but one potential implementation of the concepts disclosed herein. The PDS 1 takes the form of a modified shipping container that retains a respective corner casting 3 at each of its four lower corners. The corner castings are mounting points 3′ by which the PDS 1 is transportable in place of a shipping container.

An interior of the PDS 1 is partitioned along its length to define a product storage area 5, a foyer 7 and a return area 9. In this example, each of the areas 5, 7, 9 is a respective room. The product storage area 5 is equipped with shelving 5a upon which laundered product such as linen and/or clothing is stackable. A wall 11 separates the areas 5, 7 from each other and is equipped with a door 11a. In another embodiment, the product storage area 5 may use a plurality of trolleys as main storage devices, instead of shelving 5a.

The foyer 7 sits at one end of the PDS 1 and comprises an external door 13 that opens to the outside world outside of the PDS 1.

The foyer 7 is equipped with an RFID reader 15 to read RF-identifiable product taken from the product storage area 5. The foyer 7 thus constitutes an RFID portal 7′. The RFID reader 15 is preferably a UHF RFID reader capable of identifying product anywhere within the foyer 7. Other forms of RFID portal are possible. By way of example, one or more RFID readers mounted immediately adjacent and/or above the external door 13 might be arranged to identify a product as it moves through that door.

Whilst other forms of RFID portal are possible, an exit area in combination with a UHF RFID reader is preferred. Preferably, the foyer 7 forms the exit area, which defines an exit path that users must traverse to take product from the product storage area 5. The RFID reader 15 is configured to read product along this exit path. In this way, the RFID portal 7′ is able to identify product with relative accuracy even if a user were to swiftly move product in an effort to thwart the system.

The foyer 7 is equipped with a shelf 7a to provide a convenient point for users to place selected product whilst they go back to the product storage area 5 to collect further product. This adds to the product-residency time within the RFID portal 7′ to reduce the risk of a collected item going undetected. Preferably, the foyer 7 also incorporates a display for displaying to users a list of items that they have collected. This makes it easier for users to check off that they have all of the products that they need. In one implementation, the door 13 might be configured to unlock based on the status of the door 11a. By way of example, when an operator leaves the product storage area 5, the door 13 may remain locked until (or until a period after) the door 11a is closed. This would limit the rate at which a user can move outwardly through the RFID portal 7′ for improved accuracy.

In this implementation of the concept, the wall 11 (including the door 11a) is a shield to shield the product storage area 5 from the reader 15. In this way, the reader 15 checks product only after a user has taken it from the product storage area 5. This reduces the risk of the PDS 1 erroneously suggesting that a user has taken a particular product.

Optionally, an interlock may connect the door 11a to the reader 15 (and/or to other aspects of the product tracking system) so that when the door 11a is opened the product tracking system does not erroneously suggest that products have been taken from the product storage area 5. This might be achieved by deactivating the reader 15 when the door 11a is opened. This could be as simple as a contact switch (or a reed switch) associated with the door 11a and arranged to interrupt the power supply to the reader 15.

Preferably, substantially an entirety of an area of the wall 11 is spanned by metal. By way of example, the wall 11 might be formed of expanded polystyrene sandwiched between metallic skins.

Optionally the doorway of door 11a is spanned by an RF shielding curtain in addition to or instead of the door 11a. Preferred variants of the RF shielding curtain comprise hanging lengths of RF shielding material, e.g. RF shielding fabrics that are separable from each other so that the user can push through this curtain to get from one side of the curtain to the other. The curtain provides a simple means by which users can move between the areas 5, 7 whilst opening only a minimal unshielded area by which the reader 15 might ‘erroneously’ detect product in the product storage area 5.

A preferred variant of the curtain comprises vertical strips of flyscreen mesh. Conductive fabric is in conformal contact with the mesh. The mesh provides a mechanical substrate supporting the conductive material. The bottom edge of each strip is weighted to promote return to a free hanging position in which the strips overlap each other to occlude substantially all of the doorway. There are other options. By way of example, the curtain might substantially consist of a pair of flexible panels that has an opening, through which a user can pass, lined with magnets tending to hold the opening closed.

Other variants of the PDS 1 may incorporate physical separation instead of shielding, although shielding is preferred to provide compact space-efficient packaging. Yet other variants of the PDS 1 may do away with the RFID portal 7′ and the shielding and move the RFID reader 15 into the product storage area 5 whereby product taken from the storage area 5 might be identified by its absence from the RFID reading. Whilst variants of this rudimentary system may be advantageous in some contexts, they carry the risk of erroneously suggesting that a product has been taken if an RFID tag fails.

In this example, the laundered items are rendered RF-identifiable by the incorporation of RFID tags. By way of example, the RFID tags might be stitched into the hem of a garment or sheet. Other products may be inherently RF-identifiable, e.g. metallic items may be integrally formed with antennae configured to spectrally notch the RF backscatter.

In this example, the external door 13 is lockable and is equipped with a card reader 13a by which the door 13 is unlockable.

Preferably users are issued with mutually distinguishable access cards whereby the card reader 13a constitutes a user identification system 13′. Other forms of user identification systems are possible. This might entail user-carryable key hardware such as the access card, a fob or any convenient form of RFID tag. Other forms of user identification systems may rely on Personal Identification Numbers or biometric sensing such as fingerprint and/or facial recognition. Preferred variants of the PDS system 1 comprise a product tracking system 17 incorporating the user identification system 13′, the RFID portal 7′ and a database for logging the product taken by each user and optionally a date and time that the product was taken.

The return area 9 is partitioned from the product storage area 5 by a wall 19. The return area 9 sits at one end of the PDS 1 and comprises a door 21 that opens to the outside world. The door 21 is equipped with a card reader 23 with electronic locks configured to permit an operator (as opposed to users) to access the return area 9.

The return area 9 is equipped with one or more one-way inlet 25 to enable users to return product in need of service, e.g. to return items in need of laundering. The one-way inlet 25 may take any convenient form, such as one or more chutes shaped to accept items and impede the removal of items. ‘Air-lock’ door systems akin to the doors of letterboxes and charity bins are another option.

In this example the one-way inlet 25 is equipped with a card reader 27 by which a user may be identified. Identification systems other than the readers 23, 27 are possible.

The return area 9 is equipped with a UHF RFID reader 29 to identify the returned product. Preferably the product tracking system 1 is associated with the UHF reader 29, and preferably also the user identification system 27′ to log the returned items. In preferred variants, the returned items are logged in a database, optionally with a date and time the items were returned.

In particular preferred variants, the product tracking system 17 may incorporate information from the user identification system 13′ and RFID portal 7′ to record the product taken by each user from the product storage area 5, and the date and time the product was returned to the product return area 9. This information may be stored in a database.

In this variant, the database may more accurately track the users with products and how long they possess the products. This data may be useful for, for example, optimizing the number of laundered products stored in the product storage area 5, such that each user has sufficient access to the number and types of products that meets their needs.

In a further variant, this data may be for commercial purposes, e.g. for determining a rental charge for the time that each product was possessed by a user from the product distribution system 1.

In a variant, the returned items may be transported from the return area 9 to an external location for processing and/or laundering before being returned to the product storage area 5.

Preferred variants of the PDS 1 incorporate a power supply for operation without connection to a mains electrical supply or other external electrical supply. The PDS 1 incorporates electricity-producing solar devices 31 in the form of roof-mounted solar panels. Other implementations may comprise photovoltaics defining the roof per se. Solar thermal is another option. Preferably, the PDS 1 is configured to power up the RFID reader 15 (e.g. from standby mode or from a mode in which the reader 15 is entirely de-energised) in response to the arrival of a user, e.g. in response to a user interacting with the card reader.

Preferred variants of the PDS 1 incorporate a data outlet (such as a radio transmitter or a transmitter co-operable with a telecommunications network) for passing on (preferably wirelessly passing on) data to a service facility such as to a laundry facility. The data might be passed on via a telecommunications network (e.g. a 4G network) and/or via a satellite.

The product tracking system 17 might be a distributed system comprising hardware within the transportable unit and data processing and storage elsewhere. By way of example, raw data from the RFID reader 15 and user identification system 13′ might be transmitted to the laundry facility where the raw data is processed and logged.

In one form, the RFID reader 15 in the foyer 7, and/or the RFID reader 29 in the return area 9 each includes one or more antennas embedded within the relevant RFID readers. The antennas are arranged to transmit power to RF-identifiable product within the area, and then receive signals from the RFID tags so that the product can be correctly identified and logged by the system.

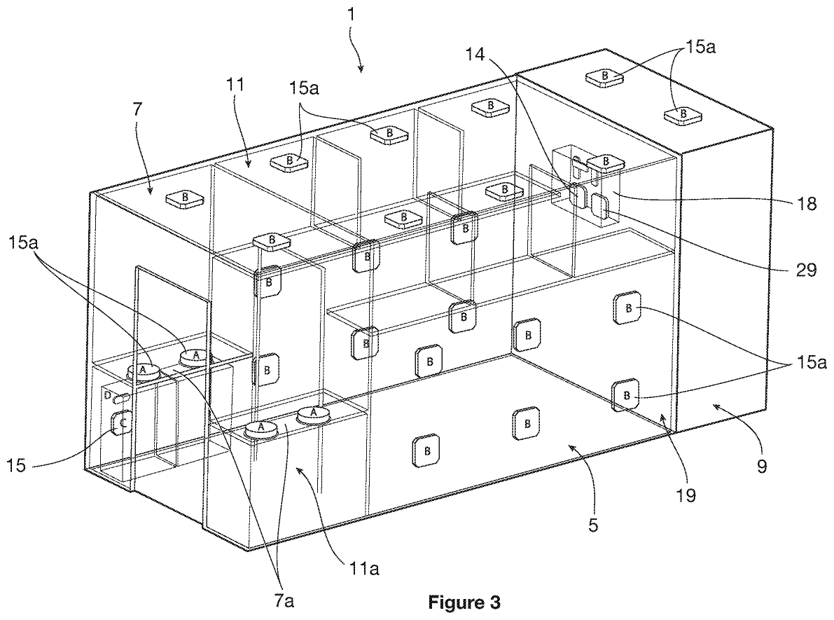

In another embodiment, to improve the accuracy of RFID signals detected by the RFID readers 15 or 29, the PDS 1 is configured such that it includes an RFID reader 15 for the foyer 7, an RFID reader 14 for the product storage area 5, and then an RFID reader 29 for the return area 9, as shown in FIG. 3. The RFID readers 14, 29 for the product storage area 5 and the return area 9 are preferably accommodated within an antenna box 18 mounted to wall 19. The antennas 15a located in the foyer 17 may be mounted underneath the bench 7a. Other antennas 15a may be mounted to ceilings or recessed into walls of the respective areas.

The invention is not limited to the various examples described herein. Rather, the invention is defined by the claims.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A product distribution system comprising:
a product storage area;
an RFID portal to identify product taken from the product storage area,
a product return area separate from the product storage area, and
an RFID reader to identify product in the product return area, the RFID reader being separate from the RFID portal.

2. A product distribution system comprising:
a product storage area;
an RFID portal to identify product taken from the product storage area, and
a shield to shield the RFID portal from the product storage area.

3. The product distribution system of claim 2 wherein the shield comprises a metallic wall.

4. The product distribution system of claim 2 or 3 comprising a transportable unit, wherein the transportable unit comprises:
the product storage area, and
a reader of the RFID portal.

5. A product distribution system comprising a transportable unit, wherein the transportable unit comprises:
a product storage area, and
a reader of an RFID portal to identify product taken from the product storage area.

6. The product distribution system of claim 4 or 5 comprising mounting points by which the transportable unit is mountable in place of a shipping container.

7. The product distribution system of any one of claims 2 to 6 comprising a product return area separate from the product storage area.

8. A product distribution system comprising:
a product storage area;
an RFID portal to identify product taken from the product storage area, and
a product return area separate from the product storage area.

9. The product distribution system of claim 1, 7 or 8 comprising a wall separating the product return area from the product storage area.

10. The product distribution system of claim 7, 8 or 9 comprising an RFID reader to identify product in the product return area.

11. The product distribution system of any one of claims 1 to 10 comprising RF-identifiable used-and-laundered product stacked, or hung, in the product storage area.

12. A product distribution system comprising:
a product storage area;
an RFID portal to identify product taken from the product storage area, and
RF-identifiable used-and-laundered product stacked, or hung, in the product storage area.

13. The product distribution system of any one of claims 1 to 12 wherein the RFID portal comprises an exit area, and a door allowing movement between the product storage area and the exit area.

14. The product distribution system of any one of claims 1 to 13 comprising a user identification system.

15. The product distribution system of claim 14 comprising a database configured to log product taken from the product storage area by each user.

16. The product distribution system of claim 14 or 15 comprising a locking system configured to grant access to the product distribution system based on user identity.

17. The product distribution system of any one of claims 1 to 16 comprising a source of electricity to operate off-mains-supply.

18. The product distribution system of any one of claims 1 to 17 comprising one or more electricity-producing solar devices.

19. The product distribution system of any one of claims 1 to 18 wherein the RFID portal is a UHF RFID portal.

20. The product distribution system of any one of claims 1 to 19 wherein the product storage area is adapted to store RF-identifiable laundered product including linens and/or clothing, which are identified by the RFID portal when taken from the product storage area.

21. The product distribution system of claim 1, 7, 8, 9 or 10 wherein the product return area is adapted to receive RF-identifiable linen and/or clothing items in need of laundering, which are identified by the RFID reader when entering the product return area.

22. A method comprising:
collecting used product to form collected product;
servicing the collected product to form serviced product;
transporting the serviced product to a product distribution system, and
allowing users to take the serviced product from the product distribution system;
wherein the product distribution system comprises:
a product storage area;
an RFID portal to identify product taken from the product storage area.

23. The method of claim 22 wherein the product distribution system is in accordance with any one of claims 1 to 21.

24. The method of claim 22 or 23 wherein the step of transporting comprises road transporting.

25. The method of claim 22, 23 or 24 wherein the step of servicing comprises laundering.
